(19) United States
(12) Patent Application Publication
(10) Pub. No.: US 2014/0290105 A1
(43) Pub. Date: Oct. 2, 2014

(54) TOW BALL COVER ASSEMBLY

(71) Applicant: Robert Calverley, Biggera Waters (AU)

(72) Inventor: Robert Calverley, Biggera Waters (AU)

(21) Appl. No.: 14/358,200

(22) PCT Filed: Nov. 13, 2012
(86) PCT No.: PCT/AU2012/001398

§ 371 Date: May 14, 2014

(30) Foreign Application Priority Data
Nov. 14, 2011 (AU) 2011904725

(51) Int. Cl. G09F 21/04; G09F 7/18

(52) U.S. Cl. CPC G09F 21/04; G09F 7/18
USPC 40/591

(57) ABSTRACT

A tow ball cover which has a body formed of resilient or flexible material having a totally hollow interior which includes an upper or head compartment which defines a socket for close retention of a tow ball characterized In that there is provide an end plate or end wall which is integral with the body and which has a rear surface for incorporation of indicia which are used for promotional, advertising or display purposes.

### FIELD OR THE INVENTION

This invention relates to a tow ball cover assembly which can be used for promotional or advertising purposes.

### BACKGROUND OF THE INVENTION

Conventional tow ball covers are well known and have been used previously for promotional or advertising purposes. Reference may be made to U.S. Pat. No. 4,181,320 for example which describes a cover or protector for a tow ball or hitch ball which is integral in nature having an outer surface and inner surface so as to define a socket for accommodation of the hitch ball or tow ball. The cover has a plurality of resilient fingers surrounding a bottom aperture for receipt of the tow ball when the cover is being fitted thereto. The outer surface may be established in the shape of a commercial product such as oil container or outboard motor power head and the like. Colour indicia may also be depicted on the outer surface. However it is an essential feature of this reference that the outer surface be in the nature of a commercial product such as an orange motor oil container, outboard motor power head or of a liquid bottle container each of which may have advertising indicia depicted on the outer surface.

However the cost of manufacture of different outer surfaces so as to represent a plethora of different commercial designs was not only impractical in relation to manufacture but also impractical for effective advertising or promotional purposes. GB 2296480 refers to a similar tow ball cover having a ball shaped socket for receiving a tow ball and which also may be luminous and also which may incorporate a decorative design such as being in the shape of a rabbit or a penguin.

U.S. Pat. No. 4,738,293 also refers to a similar tow ball cover as described above for U.S. Pat. No. 4,181,320 or GB 2296480 which has an elongate sleeve having a bottom opening or aperture and a head part in the shape of a duck or other types of animals.

However it will be appreciated that similar disadvantages applied to GB 2296480 and U.S. Pat. No. 4,738,293 as described above for U.S. Pat. No. 4,181,320.

Reference may also be made to U.S. Pat. No. 7,204,507 which describes a cover for a ball hitch that has a top wall and a peripheral wall that is attached to the top wall and which depends downwardly therefrom. The peripheral wall has a bottom edge defining an opening into the interior of the cover which forms a socket for the hitch ball in use. There is also provided a flap having an upper edge, a lower edge and a pair of side edges. The upper edge of the flap is attached to the peripheral wall and the flap extends below the bottom edge of the peripheral wall. Advertising indicia or promotional words may be provided or a forward surface of the flap that faces away from the cover, i.e. which is visible from a rear of a vehicle having a ball hitch to which the cover has been applied.

However it will be appreciated that the flap was loosely mounted on the cap and as such would tend to move in a breeze or cross winds generated by travel of a vehicle to which the cap was attached. The cap was also only a loose fit on the tow ball or hitch ball and therefore was not securely attached thereto.

### OBJECT OF THE INVENTION

It is therefore an object of the invention to provide a tow ball cover assembly which is effective in providing a large surface area for display, advertising or promotional purposes.

### SUMMARY OF THE INVENTION

The invention therefore provides a tow ball (which as used in this specification also includes within its scope the term “hitch ball”) cover which has a body formed of resilient or flexible material having a totally hollow interior which includes an upper or head compartment which defines a socket for close retention of a tow ball characterized in that there is provided an end plate or end wall which is integral with the body and which has a rear surface for incorporation of indicia which are used for display, advertising or promotional purposes.

The resilient body of the cover assembly may also have a neck portion which defines a peripheral recess for reception of a closure or securing band which may optionally be in the form of a circular clamp similar to a hose clamp or C-clamp for securing the resilient body to a corresponding neck part of the tow ball assembly which neck part is located below the tow ball.

The resilient body may also include a base compartment for accommodation of a base part of the tow ball assembly which base part is located below the neck part of the tow ball assembly.

The tow ball assembly to which the tow ball cover of the invention may be fitted may also include a support platform or plate which in use may be attached to a vehicle in any suitable or conventional manner. The resilient body may have a peripheral undersurface which is in bearing contact with an upper surface of the support plate.

The end plate or end wall may be oriented transversely to a longitudinal axis of the tow ball assembly or the tow ball cover assembly and is integral with the resilient body of the tow ball cover assembly. It is preferably coextensive or contiguous with a peripheral wall part surrounding the base compartment as well as the head compartment of the cover assembly.

The resilient body may also have a spherical wall part and a cylindrical wall part which defines the head compartment.

The end wall plate or end wall may be contiguous with the head compartment but more preferably extends past the head compartment on each side to form a pair of extensions each located laterally of the head compartment.

### DESCRIPTION OF THE PREFERRED EMBODIMENT

Reference may be made to a preferred embodiment of the invention as shown in the attached drawings wherein:

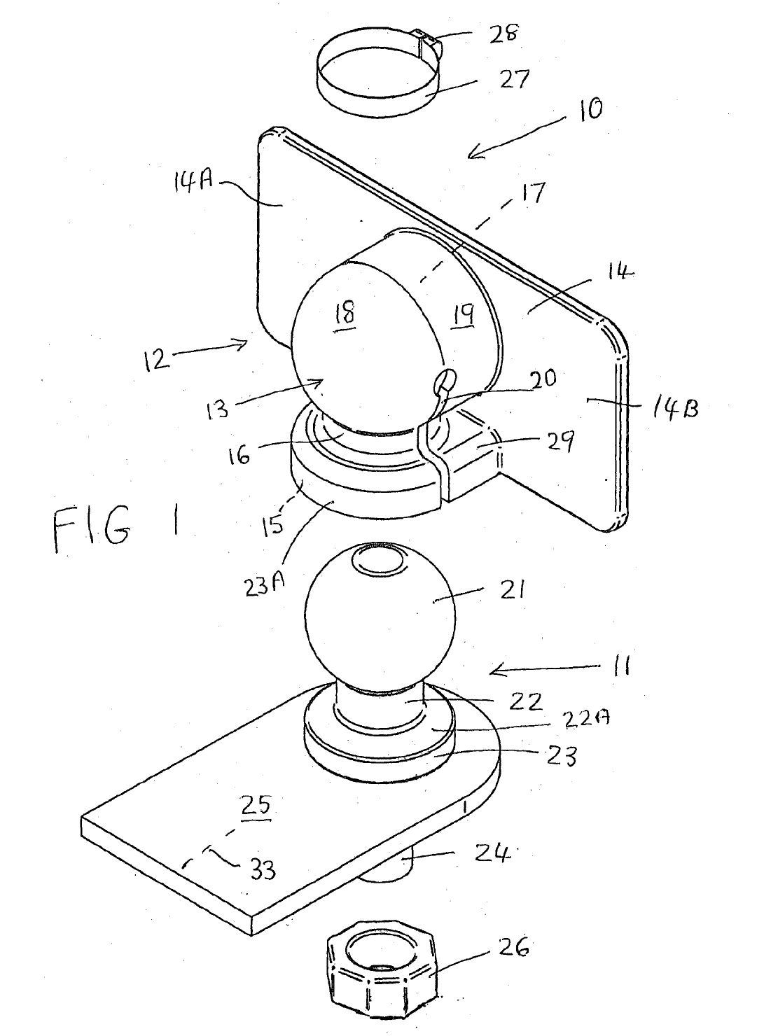

FIG. 1 is an exploded perspective view of a tow ball cover assembly of the invention and an associated tow ball assembly;

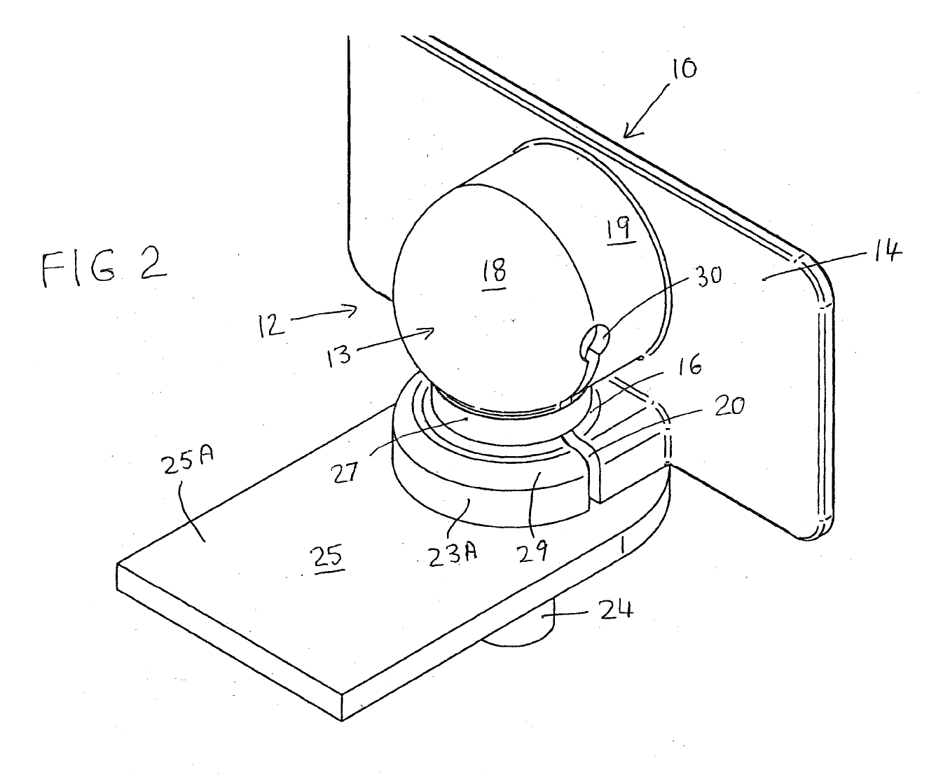

FIG. 2 is a perspective view of an assembled view of the tow ball cover assembly shown in FIG. 1 fitted to the tow ball assembly;

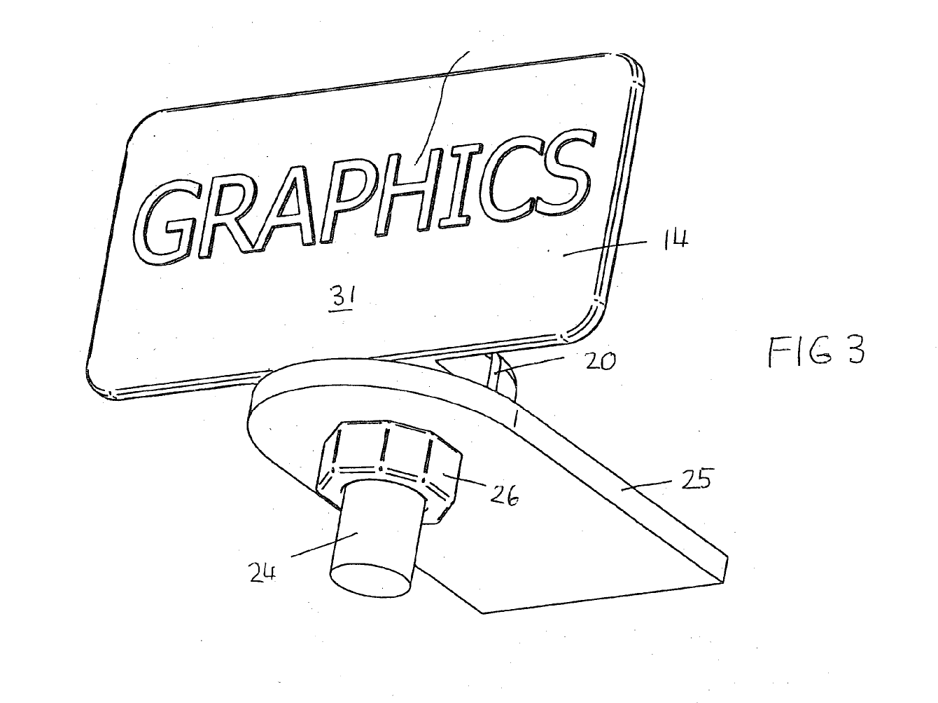

FIG. 3 is a rear perspective view of the assembled tow ball cover assembly shown in FIG. 2;

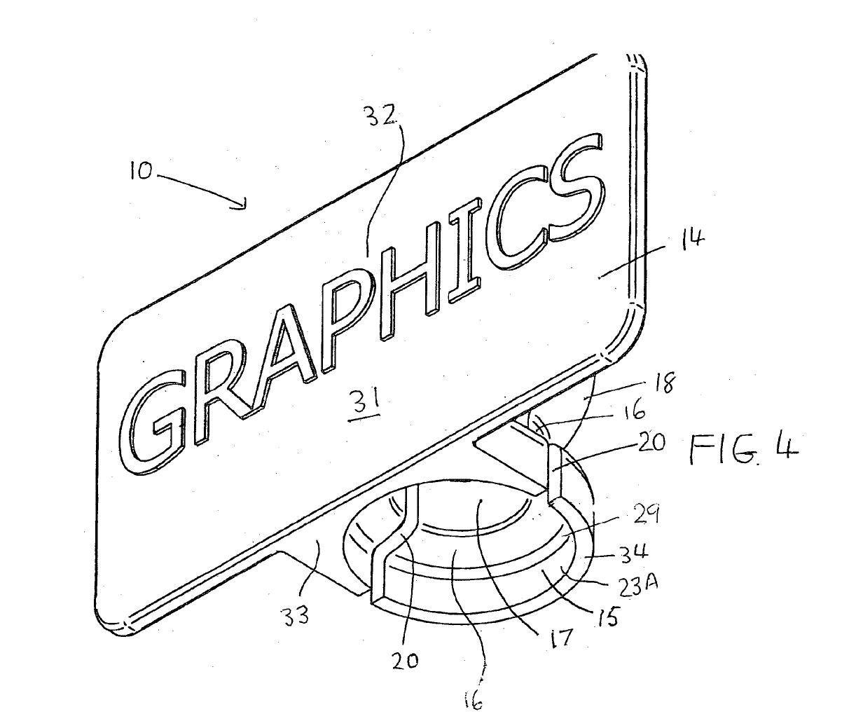

FIG. 4 is a rear perspective view of the tow ball cover assembly of the invention;

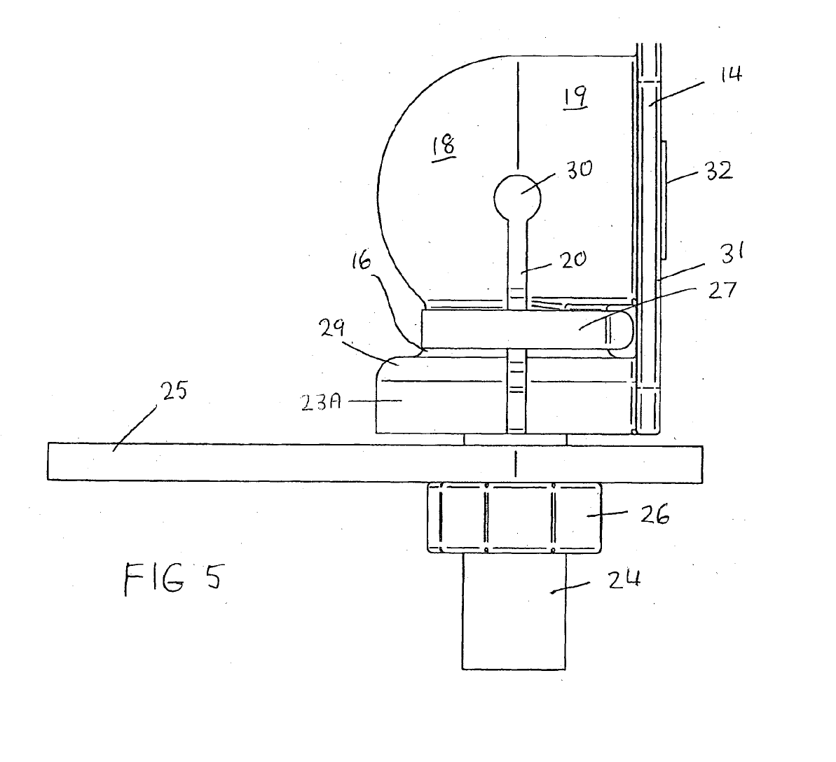

FIG. 5 is a side view of the assembled tow ball cover assembly shown in FIG. 2; and

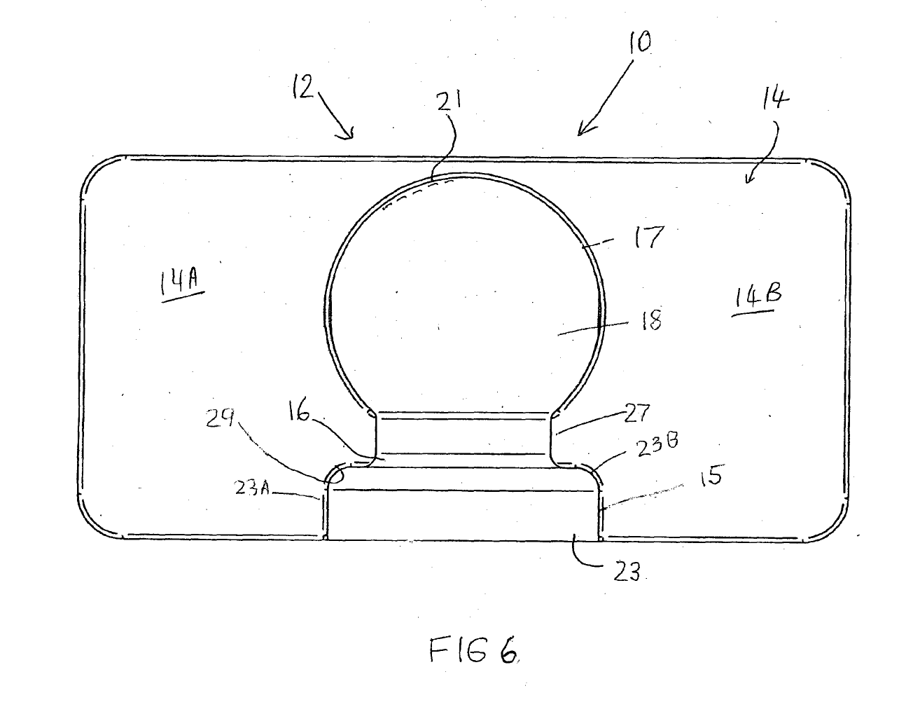

FIG. 6 is a sectional view of the assembled view shown in FIG. 2.

In FIG. 1 there is shown a tow ball cover assembly 10 to be fitted to a conventional tow ball arrangement 11. Tow ball cover assembly 10 includes cover body 12 which has a totally hollow interior 13 as well as end wall component 14. Hollow interior 13 includes a base compartment 15 and the cover body 12 includes a peripheral wall part 23A which surrounds base compartment 15. The cover body 12 also has an inwardly extending peripheral recess 16 as well as a part spherical wall 18 and part cylindrical wall 19. Hollow interior 13 also includes upper or head compartment 17. The cover body 12 also has a vertical split or elongate opening 20 which allows tow ball cover assembly 10 which may be formed from resilient plastics material to be easily fitted onto tow ball arrangement 11 which includes tow ball 21, neck part 22, base part 23 having a top surface 22A and depending shank 24 which is secured to a support plate 25 attachable to a vehicle (not shown) by threaded fastener or nut 26. Tow ball cover assembly 10 also includes a locking ring or band 27 which may be in the form of a conventional hose clamp having a screw threaded clamping part 28. Tow ball cover assembly 10 also includes rounded or tapered part 29.

FIG. 2 shows tow ball cover assembly 10 fitted to tow ball arrangement 11 wherein ball 21 fits within internal compartment 17 which is also shown in FIG. 4. Elongate opening 20 also includes enlarged end opening 30. Base part 23 also abuts peripheral wall part or base wall part 23A shown in FIG. 4. Tapered part 29 abuts tapered wall pail 23B of tow ball assembly 11 as shown in FIG. 6.

FIG. 3 shows a rear view of tow ball cover assembly 10 fitted to tow ball arrangement 11 from a rear end thereof and also shows a rear surface 31 of rear wall 14 on which may be displayed graphics or indicia 32.

FIG. 4 shows a similar view to what is shown in FIG. 3 and also shows a pair of opposed elongate openings 20 which may be used as an alternative to a single elongate opening 20. There is also shown undersurface 33 of cover assembly 10 as well as peripheral undersurface 34 of base 15 which contacts a top surface 25A of support plate 25 in use shown in FIG. 1.

FIG. 5 shows a side view of what is shown in FIG. 1 and shows indicia 32 being applied to rear surface 31 of end wall 14.

FIG. 6 shows a sectional view through the assembly of FIG. 2 and shows base compartment 15 surrounded by wall 23A, tapered surface 29 which abuts tapered surface 23B, and internal compartment 17.

It will be appreciated from the foregoing that the tow ball assembly 10 of the invention is very securely fitted to the tow ball assembly 11 by tow ball 21 fitting smugly within head compartment 17 as shown by the line in phantom indicating tow ball 21 in FIG. 6. Also base part 23 fits snugly within base compartment 15. This secure attachment is accentuated by the use of locking band 27 fitting securely in recess 16. The provision of end wall 14 which has a pair of lateral extensions 14A and 14B on either side of head compartment 17 provides a large surface area for depiction of indicia 32 which is effective in use and provides a substantial improvement over prior art such as U.S. Pat. No. 7,204,507 because end wall 14 is integral with body 12. FIG. 1 also defines a longitudinal axis 33 of tow ball assembly 11. Also the provision of a single or pair of vertical splits 20 ensures speed and efficient removal of tow ball cover assembly 10 from tow ball assembly 11 after removal of locking band 27.

It will also be appreciated that indicia 2 may be licensed trade marks of professional sports teams, advertising or other promotional matter and indicia 32 may be engraved, embossed, printed or otherwise formed on rear surface 31 (wherein the term “rear” has regard to the direction of travel of tow ball arrangement 11). Indicia 32 may also be luminous or phosphorescent if required.

1. A tow ball cover which has a body formed of resilient or flexible material having a totally hollow interior which includes an upper or head compartment which defines a socket for close retention of a tow ball n use characterized in that there is provided an end plate or end wall which is integral with the body and which has a rear surface for incorporation of indicia which are used for display, advertising and promotional purposes.

2. A tow ball cover as claimed in claim 1 wherein the resilient or flexible body has a neck portion which defines a peripheral recess for reception of a closure or security band for securing the resilient or flexile body to a corresponding neck part of a tow ball assembly which incorporates the tow ball.

3. A tow ball cover as claimed in claim 2 having a base compartment for accommodation of a base part of the tow ball assembly in use.

4. A tow ball cover as claimed in claim 1 having a peripheral undersurface which in use is in bearing contact with a support plate of the tow ball assembly.

5. A tow ball cover as claimed in claim 1 wherein the end plate or end wall is oriented transversely to a longitudinal axis of the tow ball cover.

6. A tow ball cover as claimed in claim 1 wherein the end plate or end wall is co-extensive or contiguous with a base wall of the tow ball cover as well as the upper or head compartment.

7. A tow ball cover as claimed in claim 1 wherein the tow ball cover has a spherical wall part and a cylindrical wall part which defines the upper or head compartment.

8. A tow ball cover as claimed in claim 1 wherein the end wall or end plate has a pair of extensions each located laterally of the upper or head compartment.

9. A combination of (a) a tow ball assembly; and (b) a tow ball cover wherein the tow ball assembly (a) includes a support plate for attachment to a vehicle which has a tow ball component attached thereto which includes a base part, a neck part and a tow ball wherein the tow ball cover (b) includes a resilient or flexible body which has a base compartment for reception of the base part, a hollow recess for enclosing the neck part, and an upper or head compartment for receiving the tow ball characterized in that the tow ball cover is provided with an end plate or end wall integral with the base compartment, and the upper or head compartment wherein the end wall or end plate has a pair of extensions which extend laterally on a respective side of the upper or head compartment to provide a large surface area for depiction of indicia for promotional, advertising or display purposes.

10. A tow ball cover as claimed in claim 3 having a peripheral undersurface which in use is in bearing contact with a support plate of the tow ball assembly.

11. A tow ball cover as claimed in claim 10 wherein the end plate or end wall is oriented transversely to a longitudinal axis of the tow ball cover.

12. A tow ball cover as claimed in claim 11 wherein the end plate or end wall is co-extensive or contiguous with a base wall of the tow ball cover as well as the upper or head compartment.

13. A tow ball cover as claimed in claim 12 wherein the tow ball cover has a spherical wall part and a cylindrical wall part which defines the upper or head compartment.

14. A tow ball cover as claimed in claim 13 wherein the end wall or end plate has a pair of extensions each located laterally of the upper or head compartment.
